(19) United States
(12) Patent Application Publication
(10) Pub. No.: US 2026/0219220 A1
(43) Pub. Date: Jul. 30, 2026

(54) ELECTROCHEMICAL SENSOR UNIT, ODOR COMPONENT ELECTROCHEMICAL SENSOR UNIT, AND METHOD FOR MANUFACTURING ELECTROCHEMICAL SENSOR UNIT

(71) Applicant: SONY SEMICONDUCTOR SOLUTIONS CORPORATION, KANAGAWA (JP)

(72) Inventors: NAO YOSHIMOTO, KANAGAWA (JP); YUSAKU SUGIMORI, KANAGAWA (JP); YURI KATO, KANAGAWA (JP); NAOKI NISHI, KANAGAWA (JP)

(21) Appl. No.: 19/145,728

(22) PCT Filed: Dec. 20, 2023
(86) PCT No.: PCT/JP2023/045599

§ 371 Date: Jul. 3, 2025

(30) Foreign Application Priority Data
Jan. 11, 2023 (JP) 2023-002449

(51) Int. Cl. G01N 27/02

(52) U.S. Cl. CPC G01N 27/02

(57) ABSTRACT

The present technology provides an electrochemical sensor unit and the like including two or more electrochemical sensor parts each connected to one AC signal generation unit, in which each of the electrochemical sensor parts includes a sensitive membrane having a physical property that changes in response to a chemical substance in a sample, and the sensitive membranes are separated from each other via at least one of an insulating membrane or an electrode in plan view. At least some of the electrochemical sensor parts may be arranged in an array.

### TECHNICAL FIELD

The present technology relates to an electrochemical sensor unit, an odor component electrochemical sensor unit, and a method for manufacturing the electrochemical sensor unit.

### BACKGROUND ART

Electrochemical sensors are one of the most common sensors currently used in industry and are used in a wide range of applications such as gas sensing, water quality test, bioanalysis, and food test. By using this type of sensor, it is possible to detect a chemical substance on the basis of an electronic parameter generated using an electrochemical reaction derived from a type or concentration of the chemical substance.

For example, Patent Document 1 discloses a technology relating to an odor sensor that detects an odor substance as an example of this chemical substance.

### CITATION LIST

### Patent Document

Patent Document 1: Japanese Patent Application Laid-Open No. 2020-8522

### SUMMARY OF THE INVENTION

### Problems to be Solved by the Invention

However, in order to accurately detect a chemical substance in a sample, it is preferable that sensitive membranes having physical properties that change in response to the chemical substance are arranged separated from each other. This allows the electrochemical sensor unit to include, for example, a plurality of types of sensitive membranes. Patent Document 1 does not mention a technology for separating sensitive membranes.

Thus, a main object of the present technology is to provide an electrochemical sensor unit, an odor component electrochemical sensor unit, and an electrochemical sensor unit capable of accurately detecting a plurality of chemical substances in a sample by arranging sensitive membranes to be separated from each other.

### Solutions to Problems

The present technology provides an electrochemical sensor unit including
two or more electrochemical sensor parts each connected to one alternating current (AC) signal generation unit, in which
each of the electrochemical sensor parts includes a sensitive membrane having a physical property that changes in response to a chemical substance in a sample, and
the sensitive membranes are separated from each other via at least one of an insulating membrane or an electrode in plan view.

At least some of the electrochemical sensor parts may be arranged in an array.

Types of the sensitive membranes included in two or more of the electrochemical sensor parts may be different from each other.

The sensitive membrane may have a contact surface in contact with the chemical substance, and
the contact surfaces included in two or more of the electrochemical sensor parts each may have a different size.

Sizes of the contact surfaces may be different depending on the types of the sensitive membranes.

Frequencies of the AC signal generation unit to be input to two or more of the electrochemical sensor parts may be different from each other.

Frequencies of the AC signal generation unit to be input to two or more of the electrochemical sensor parts may be different depending on at least one of the types or sizes of the sensitive membranes.

The electrochemical sensor unit may further include one or more response signal output circuits that output response signals from the electrochemical sensor parts, in which
at least some of the response signal output circuits may include an in-phase/quadrature-phase (IQ) conversion circuit, and
at least some of the electrodes may include an IQ electrode connected to the IQ conversion circuit and an AC electrode connected to the AC signal generation unit.

The sensitive membrane may have a contact surface in contact with the chemical substance, and
the IQ electrode and the AC electrode may be arranged on an opposite side of the contact surface.

An area where the IQ electrode and the sensitive membrane are in contact with each other and an area where the AC electrode and the sensitive membrane are in contact with each other may be substantially same.

One of the electrochemical sensor parts may be connected to one of the IQ conversion circuits.

Two or more of the electrochemical sensor parts each may be connected to one of the IQ conversion circuits.

The electrochemical sensor unit may further include an identification system unit that identifies the chemical substance on the basis of outputs from the response signal output circuits.

The sensitive membrane may contain an organic polymer.

The sensitive membrane may contain an inorganic material.

The sensitive membrane may contain an olfactory cell.

The sample may be in any of a gaseous state, a liquid state, a semi-solid state, and a solid state.

In addition, the present technology provides an odor component electrochemical sensor unit including
two or more electrochemical sensor parts each connected to one AC signal generation unit, in which
each of the electrochemical sensor parts includes a sensitive membrane having a physical property that changes in response to an odor component in a sample, and
the sensitive membranes are separated from each other via at least one of an insulating membrane or an electrode in plan view.

In addition, the present technology provides a method for manufacturing an electrochemical sensor unit, the method including:
forming sensitive membranes having a physical property that changes in response to a chemical substance in a sample; and
separating the sensitive membranes from each other via at least one of an insulating membrane or an electrode in plan view.

According to the present technology, an electrochemical sensor unit, an odor component electrochemical sensor unit, and an electrochemical sensor unit capable of accurately detecting a plurality of chemical substances in a sample can be provided. Note that the effects described herein are not necessarily limited, and any of the effects described in the present disclosure may be exhibited.

### BRIEF DESCRIPTION OF DRAWINGS

FIG. 1 is a circuit diagram illustrating a configuration example of an electrochemical sensor unit 1 according to an embodiment of the present technology.

FIG. 2 is a schematic cross-sectional view illustrating a configuration example of an electrochemical sensor part 12 according to an embodiment of the present technology.

FIG. 3 is a schematic plan view illustrating a configuration example of the electrochemical sensor part 12 according to an embodiment of the present technology.

FIG. 4 is a schematic cross-sectional view illustrating a configuration example of the electrochemical sensor part 12 according to an embodiment of the present technology.

FIG. 5 is a schematic plan view illustrating a configuration example of the electrochemical sensor part 12 according to an embodiment of the present technology.

FIG. 6 is a schematic plan view illustrating a configuration example of the electrochemical sensor part 12 according to an embodiment of the present technology.

FIG. 7 is a schematic plan view illustrating a configuration example of the electrochemical sensor part 12 according to an embodiment of the present technology.

FIG. 8 is a schematic cross-sectional view illustrating a configuration example of the electrochemical sensor part 12 according to an embodiment of the present technology.

FIG. 9 is a schematic plan view illustrating a configuration example of the electrochemical sensor part 12 according to an embodiment of the present technology.

FIG. 10 is a schematic plan view illustrating a configuration example of the electrochemical sensor part 12 according to an embodiment of the present technology.

FIG. 11 is a schematic plan view illustrating a configuration example of the electrochemical sensor part 12 according to an embodiment of the present technology.

FIG. 12 is a schematic plan view illustrating a configuration example of the electrochemical sensor part 12 according to an embodiment of the present technology.

FIG. 13 is a schematic cross-sectional view illustrating a configuration example of an electrochemical sensor part 12 according to an embodiment of the present technology.

FIG. 14 is a schematic plan view illustrating a configuration example of the electrochemical sensor part 12 according to an embodiment of the present technology.

FIG. 15 is a schematic plan view illustrating a configuration example of the electrochemical sensor part 12 according to an embodiment of the present technology.

FIG. 16 is a schematic plan view illustrating a configuration example of the electrochemical sensor part 12 according to an embodiment of the present technology.

FIG. 17 is a schematic cross-sectional view illustrating a configuration example of an electrochemical sensor part 12 according to an embodiment of the present technology.

FIG. 18 is a block diagram illustrating a configuration example of an apparatus 10 including an electrochemical sensor part 12 according to an embodiment of the present technology.

FIG. 19 is a schematic cross-sectional view illustrating a configuration example of the electrochemical sensor part 12 according to an embodiment of the present technology.

FIG. 20 is a schematic cross-sectional view illustrating a configuration example of the electrochemical sensor part 12 according to an embodiment of the present technology.

FIG. 21 is a circuit diagram illustrating a configuration example of a circuit including an electrochemical sensor unit 1 according to an embodiment of the present technology.

FIG. 22 is a block diagram illustrating a configuration example of an apparatus 10 including the electrochemical sensor part 12 according to an embodiment of the present technology.

FIG. 23 is a schematic cross-sectional view illustrating a configuration example of the electrochemical sensor part 12 according to an embodiment of the present technology.

FIG. 24 is a schematic cross-sectional view illustrating a configuration example of the electrochemical sensor part 12 according to an embodiment of the present technology.

FIG. 25 is a schematic plan view illustrating an example of shapes of an electrode 123 according to an embodiment of the present technology.

FIG. 26A is a schematic cross-sectional view for explaining a method for manufacturing an electric sensor unit according to an embodiment of the present technology.

FIG. 26B is a schematic cross-sectional view for explaining the method for manufacturing the electric sensor unit according to an embodiment of the present technology.

FIG. 26C is a schematic cross-sectional view for explaining the method for manufacturing the electric sensor unit according to an embodiment of the present technology.

FIG. 26D is a schematic cross-sectional view for explaining the method for manufacturing the electric sensor unit according to an embodiment of the present technology.

FIG. 26E is a schematic cross-sectional view for explaining the method for manufacturing the electric sensor unit according to an embodiment of the present technology.

FIG. 26F is a schematic cross-sectional view for explaining the method for manufacturing the electric sensor unit according to an embodiment of the present technology.

FIG. 26G is a schematic cross-sectional view for explaining the method for manufacturing the electric sensor unit according to an embodiment of the present technology.

FIG. 26H is a schematic cross-sectional view for explaining the method for manufacturing the electric sensor unit according to an embodiment of the present technology.

FIG. 26I is a schematic cross-sectional view for explaining the method for manufacturing the electric sensor unit according to an embodiment of the present technology.

FIG. 26J is a schematic cross-sectional view for explaining the method for manufacturing the electric sensor unit according to an embodiment of the present technology.

FIG. 26K is a schematic cross-sectional view for explaining the method for manufacturing the electric sensor unit according to an embodiment of the present technology.

FIG. 27A is a schematic cross-sectional view for explaining a method for manufacturing an electric sensor unit according to an embodiment of the present technology.

FIG. 27B is a schematic cross-sectional view for explaining the method for manufacturing the electric sensor unit according to an embodiment of the present technology.

FIG. 27C is a schematic cross-sectional view for explaining the method for manufacturing the electric sensor unit according to an embodiment of the present technology.

FIG. 27D is a schematic cross-sectional view for explaining the method for manufacturing the electric sensor unit according to an embodiment of the present technology.

FIG. 27E is a schematic cross-sectional view for explaining the method for manufacturing the electric sensor unit according to an embodiment of the present technology.

FIG. 27F is a schematic cross-sectional view for explaining the method for manufacturing the electric sensor unit according to an embodiment of the present technology.

FIG. 27G is a schematic cross-sectional view for explaining the method for manufacturing the electric sensor unit according to an embodiment of the present technology.

FIG. 27H is a schematic cross-sectional view for explaining the method for manufacturing the electric sensor unit according to an embodiment of the present technology.

FIG. 27I is a schematic cross-sectional view for explaining the method for manufacturing the electric sensor unit according to an embodiment of the present technology.

FIG. 27J is a schematic cross-sectional view for explaining the method for manufacturing the electric sensor unit according to an embodiment of the present technology.

### MODE FOR CARRYING OUT THE INVENTION

Hereinafter, preferred embodiments for carrying out the present technology will be described with reference to the drawings. Note that the embodiments to be described below each illustrate an example of a representative embodiment of the present technology, and the scope of the present technology is not limited by this. In addition, in the present technology, any of the following embodied examples and modifications thereof can be combined.

In the following description of the embodiments, the configuration may be sometimes described using terms with “substantially”, such as substantially parallel or substantially orthogonal. For example, “substantially parallel” means not only being completely parallel, but also means to also include being practically parallel, that is, a state shifted by, for example, about several percent from the completely parallel state. This similarly applies to other terms with “substantially”. In addition, each drawing has a schematic view and is not necessarily strictly illustrated. The scale of the drawings is exaggerated to facilitate understanding of the technological features. Therefore, it should be noted that the scale of the drawings and the scale of the actual devices are not necessarily the same.

Unless otherwise specified, in the drawings, “upper” means an upward direction or an upper side in the drawing, “lower” means a downward direction or a lower side in the drawing, “left” means a leftward direction or a left side in the drawing, and “right” means a rightward direction or a right side in the drawing. In addition, in the drawings, the same or equivalent elements or members are denoted by the same reference signs, and redundant description will be omitted.

The description will be given in the following order.
1. First Embodiment of Present Technology (Example 1 of Electrochemical Sensor Unit)
(1) Electrochemical Sensor Circuit
(2) AC Signal Generation Unit
(3) Electrochemical Sensor Part
(4) Response Signal Output Circuit
(5) Identification System Unit
(6) Configuration Example of Electrochemical Sensor Part
(7) Configuration Example of Sensitive Membrane
(8) Configuration Example of Electrode
2. Second Embodiment of Present Technology (Example 2 of Electrochemical Sensor Unit)
3. Third Embodiment of Present Technology (Example 3 of Electrochemical Sensor Unit)
4. Fourth Embodiment of Present Technology (Example 4 of Electrochemical Sensor Unit)
5. Fifth Embodiment of Present Technology (Example 5 of Electrochemical Sensor Unit)
6. Sixth Embodiment of Present Technology (Example 6 of Electrochemical Sensor Unit)
7. Seventh Embodiment of Present Technology (Example of Odor Component Electrochemical Sensor Unit)
8. Eighth Embodiment of Present Technology (Example 1 of Method for Manufacturing Electrochemical Sensor Unit)
9. Ninth Embodiment of Present Technology (Example 2 of Method for Manufacturing Electrochemical Sensor Unit)

### 1. First Embodiment of Present Technology (Example 1 of Electrochemical Sensor Unit)

### [(1) Electrochemical Sensor Circuit]

The present technology provides an electrochemical sensor unit including two or more electrochemical sensor parts each connected to one AC signal generation unit, in which each of the electrochemical sensor parts includes a sensitive membrane having a physical property that changes in response to a chemical substance in a sample, and the sensitive membranes are separated from each other via at least one of an insulating membrane or an electrode in plan view.

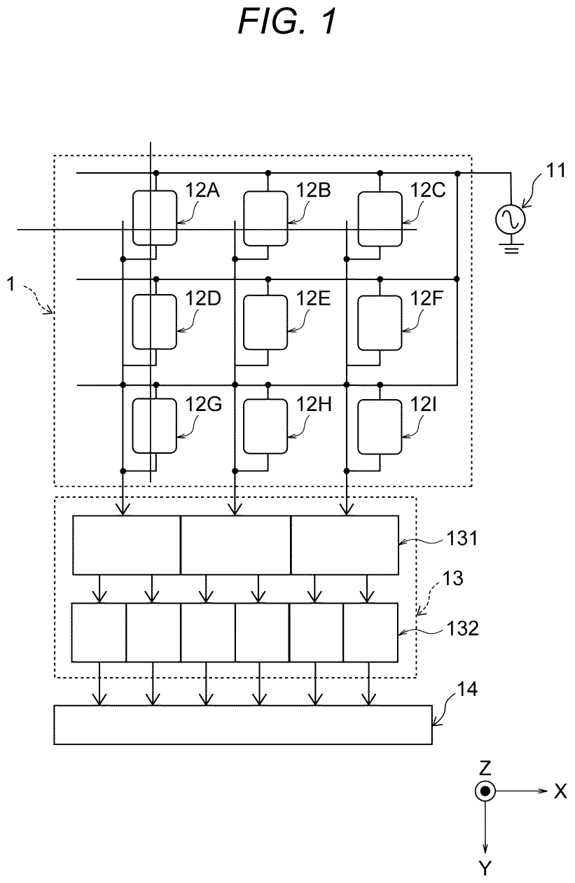

The electrochemical sensor unit according to an embodiment of the present technology constitutes an electrochemical sensor circuit that identifies a chemical substance in a sample. This electrochemical sensor unit will be described with reference to FIG. 1. FIG. 1 is a circuit diagram illustrating a configuration example of an electrochemical sensor unit 1 according to an embodiment of the present technology.

As illustrated in FIG. 1, the electrochemical sensor unit 1 includes two or more electrochemical sensor parts 12A to 12I each connected to one AC signal generation unit 11. Then, the electrochemical sensor unit 1 may further include one or more response signal output circuits 13 that output response signals from the electrochemical sensor parts 12A to 12I, and an identification system unit 14 that identifies the chemical substance in the sample on the basis of outputs from response signal output circuits 13.

At least some of the response signal output circuits 13 include an IQ conversion circuit 131 and an analog-to-digital (AD) conversion circuit 132. This can improve identification accuracy. The IQ conversion circuit 131 and the AD conversion circuit 132 will be described later.

Note that, in the present description, “chemical substance” is an object to be identified contained in a sample and means any chemical substance such as a simple substance, a pure substance constituted with a compound, or a mixture. In addition, the origin of the chemical substance is also not particularly limited and is not restricted to natural origin, and the chemical substance may be artificially derived.

Note that, in the present description, “sample” means any sample including a biological sample. In addition, in the present technology, a state of the sample is not particularly limited, but is preferably any of a gaseous state, a liquid state, a semi-solid state, and a solid state, and is particularly preferably a gaseous state. Note that the gas refers to a gas that is completely vaporized at normal temperature (25° C.). In addition, the liquid refers to a liquid that is completely liquefied at normal temperature. Furthermore, the solid refers to a solid that is completely solidified at normal temperature. Besides, the semi-solid refers to a semi-solid having a melting point of 25° C. or higher but not completely solidified at normal temperature. The chemical substance in the sample may be fixed to the sample by adhesion, adsorption, burying, or the like, or may float in the sample without being fixed.

### [(2) AC Signal Generation Unit]

The AC signal generation unit 11 generates an AC signal. In the present embodiment, a frequency of the AC signal generation unit 11 can be fluctuated in any range and used variably. As a result, for example, AC signals can be applied at different frequencies for each of the electrochemical sensor parts 12A to 12I to be described later. The frequency of the AC signal generation unit 11 is not particularly limited, and any frequency (such as a range from 1 kHz to 10 MHz, for example) can be used.

Note that, in the present embodiment, the frequency of the AC signal generation unit 11 may be controlled on the basis of an identification result of the identification system unit 14 to be described later.

In addition, in the present embodiment, the number of the AC signal generation units 11 is not particularly limited as long as there are one or more AC signal generation units 11. In a case where there are two or more AC signal generation units 11, frequencies output from the respective AC signal generation units 11 may be the same, but some or all of them may be different.

In a case where there are two or more AC signal generation units 11, the respective AC signal generation units 11 may have frequencies different for each row or column of the electrochemical sensor parts 12A to 12I or some of the response signal output circuits 13 arranged in an array.

### [(3) Electrochemical Sensor Part]

The electrochemical sensor part 12 to 12I generate an electronic parameter (such as a current, a voltage, capacity, impedance, for example, preferably impedance) that is a response signal, using an electrochemical reaction derived from a type, concentration, or the like of a chemical substance. In the present embodiment, it is sufficient that two or more electrochemical sensor parts 12 to 12I are provided for one AC signal generation unit 11, and the number of electrochemical sensor parts 12 to 12I is not particularly limited.

The electrochemical sensor parts 12 to 12I are not particularly limited, and a conventionally known electrochemical sensor can be used. Among conventionally known electrochemical sensors, an electrochemical sensor based on amperometry (that is, a current measurement sensor) is common.

In the present embodiment, by providing at least two or more electrochemical sensor parts 12A to 12I each connected to one AC signal generation unit 11, a plurality of chemical substances in a sample can be accurately identified.

At this time, at least some of the electrochemical sensor parts 12A to 12I are preferably arranged in an array. As a result, measurements can be taken at an optimal frequency for each of types and sizes of membranes constituting the electrochemical sensor parts 12A to 12I, and a gas in which a plurality of components are mixed, such as a gas containing an odor component, or the like can be identified from a difference in response signals caused by the types or sizes of the membranes. In addition, area efficiency of peripheral circuits of the electrochemical sensor parts 12 to 12I is improved. Furthermore, by controlling driving of the AC signal generation unit 11 and the like in accordance with an identification status or the like, further improvement of the identification accuracy can be expected. Note that the configuration of the electrochemical sensor parts 12 will be described later.

Note that, in this circuit configuration example, the electrochemical sensor parts 12 are two-dimensionally arrayed in M rows and N columns (M and N are integers equal to or greater than two), but the circuit configuration is not limited to this configuration. For example, the electrochemical sensor parts 12 may be one-dimensionally arrayed in one row and N columns.

### [(4) Response Signal Output Circuit]

The response signal output circuit 13 outputs response signals from the electrochemical sensor parts 12A to 12I. In the present embodiment, the number of the response signal output circuits 13 is not particularly limited as long as there are one or more response signal output circuits 13.

At least some of the response signal output circuits 13 include the IQ conversion circuit 131 and the AD conversion circuit 132. This can improve the identification accuracy.

The IQ conversion circuit 131 extends (converts) a signal to be handled into a complex signal.

Specifically, an I signal having the same phase (In-Phase) as a reference signal and a Q signal having a Quadrature-Phase shifted by 90° from the phase of the reference signal are generated. The IQ conversion circuit 131 supplies these I signal and Q signal to the AD conversion circuit 132.

The AD conversion circuit 132 converts the I signal and the Q signal in an analog format into signals in a digital format and supplies the converted signals to the identification system unit 14. As the AD conversion circuit 132, for example, a conventionally known single-slope AD converter or the like can be used. In the single-slope AD converter, an analog signal to be processed is converted into a digital signal on the basis of a period from start of conversion until a reference voltage matches a voltage of the signal to be processed. As a mechanism for this, for example, a comparator (voltage comparator) that compares a single-slope waveform with an output signal direct current (DC) level of the IQ conversion circuit and a counter that quantifies a comparison period can be used. Then, the reference voltage is supplied and counting with a clock signal is started at the same time, and AD conversion is performed by comparing the signal DC level output from the IQ conversion circuit with the reference voltage and counting until a pulse signal is obtained.

The AD conversion circuits 132 are arranged and laid out in a column direction with respect to the IQ conversion circuits 131 arranged in an array. With such a circuit configuration, layout efficiency can be enhanced, and an entire area of the electrochemical sensor circuit can be reduced. Note that, although not illustrated, in the present embodiment, the AD conversion circuits 132 may be arranged and laid out in a row direction with respect to the IQ conversion circuits 131 arranged in an array.

In the present embodiment, the AD conversion circuit 132 may lower noise by performing multi-sampling (a plurality of times of operation). This can improve the identification accuracy.

In addition, in the present embodiment, in the response signal output circuit 13, a circuit constant may be freely altered by, for example, altering a band to be cut by a low-pass filter (LPF) according to the types, sizes, and the like of the sensitive membranes constituting the electrochemical sensor parts 12. This can optimize the circuit constant in accordance with the types, sizes, and the like of the sensitive membranes and improve the identification accuracy.

Furthermore, in the present embodiment, at least some of the response signal output circuits 13 may not be arranged in an array. In addition, at least two or more of the electrochemical sensor parts 12A to 12I each may be connected to one of the response signal output circuits 13.

In addition, in the present embodiment, in a case where the frequency of the AC signal generation unit 11 is variably used as described above, the response signal output circuit 13 may include two or more switches, and the respective switches and frequencies of the AC signal generation unit 11 may be controlled in accordance with the electrochemical sensor parts 12A to 12I.

### [(5) Identification System Unit]

The identification system unit 14 identifies a chemical substance in a sample on the basis of an output from the response signal output circuit 13. In the present embodiment, the number of the identification system units 14 is not particularly limited as long as there are one or more identification system units 14.

In the present embodiment, the identification system unit 14 may identify a chemical substance in a sample by checking the response signals for each electrochemical sensor part 12 against a database. The identification result of the identification system unit 14 may be fed back to control the frequency in the AC signal generation unit 11. This can promote improvement of the identification accuracy and improvement of identification speed.

### [(6) Configuration Example of Electrochemical Sensor Part]

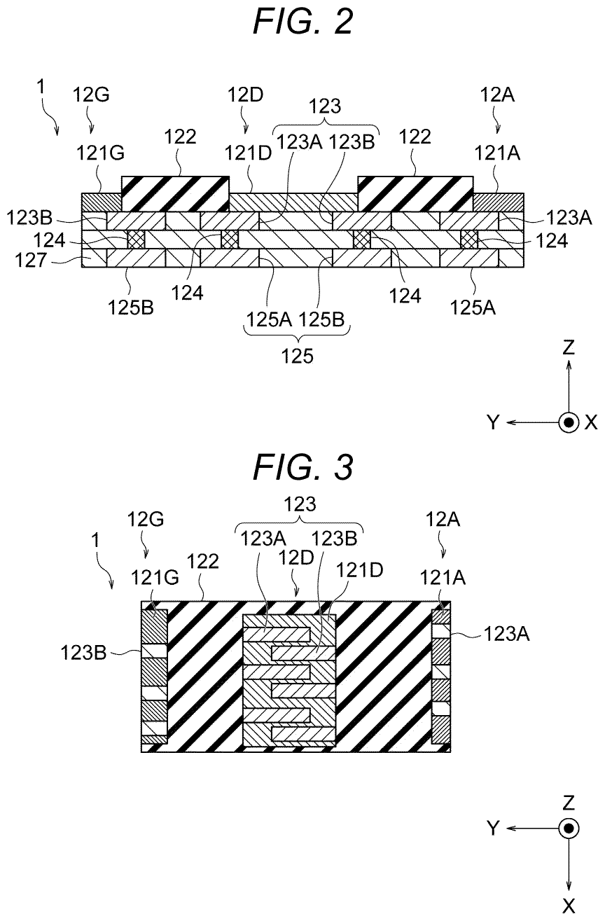

A configuration example of the electrochemical sensor part 12 will be described with reference to FIGS. 2 and 3. FIG. 2 is a schematic cross-sectional view illustrating a configuration example of the electrochemical sensor part 12 according to an embodiment of the present technology. FIG. 3 is a schematic plan view illustrating a configuration example of the electrochemical sensor part 12 according to an embodiment of the present technology. In more detailed description, FIG. 2 is a cross-sectional view taken along a first cutting line (a cutting line passing through the electrochemical sensor parts 12A, 12D, and 12G) illustrated in FIG. 1. FIG. 2 is a plan view along this first cutting line.

As illustrated in FIGS. 2 and 3, the electrochemical sensor parts 12A, 12D, and 12G include sensitive membranes 121A, 121D, and 121G having physical properties that change in response to a chemical substance in a sample, respectively.

Note that, in the present description, “membrane” includes a membrane having any hardness, and both a very rigid membrane and a very flexible membrane are included in “membrane”. Examples of the membrane include a metal membrane of platinum, gold, or the like, membranes of graphite carbon, boron-doped diamond, etc., a polymer membrane formed with a conductive polymer such as polyaniline or polythiophene. In the present embodiment, a size (such as several μm² to several mm², for example), an area, a thickness, and the like of the membrane are not particularly limited.

The AC signal from the AC signal generation unit 11 is input to each of the sensitive membranes 121A, 121D, and 121G. Each of the sensitive membranes 121A, 121D, and 121G adsorbs a chemical substance in the sample to react with this chemical substance, thereby changing the physical property and generating an electronic parameter that is a response signal.

The sensitive membranes 121 including the sensitive membranes 121A, 121D, and 121G only need to be able to generate the electronic parameters that are response signals, and the type of the sensitive membranes 121 is not particularly limited. The sensitive membrane may contain, for example, an organic polymer. Examples of the organic polymer can include polyaniline.

Alternatively, the sensitive membrane may contain, for example, an inorganic material. Examples of the inorganic material can include a metal oxide. Examples of the metal can include molybdenum and aluminum.

Alternatively, the sensitive membrane may include, for example, an olfactory cell. The olfactory cell is a cell that receives an odor component that is an example of the chemical substance. A technology relating to olfactory cells are disclosed in the following non-patent document.

### Non-Patent Document

An ultrasensitive electrochemical impedance-based biosensor using insect odorant receptors to detect odorants, Biosensors and Bioelectronics, 2019, Vol. 126, p. 207-213

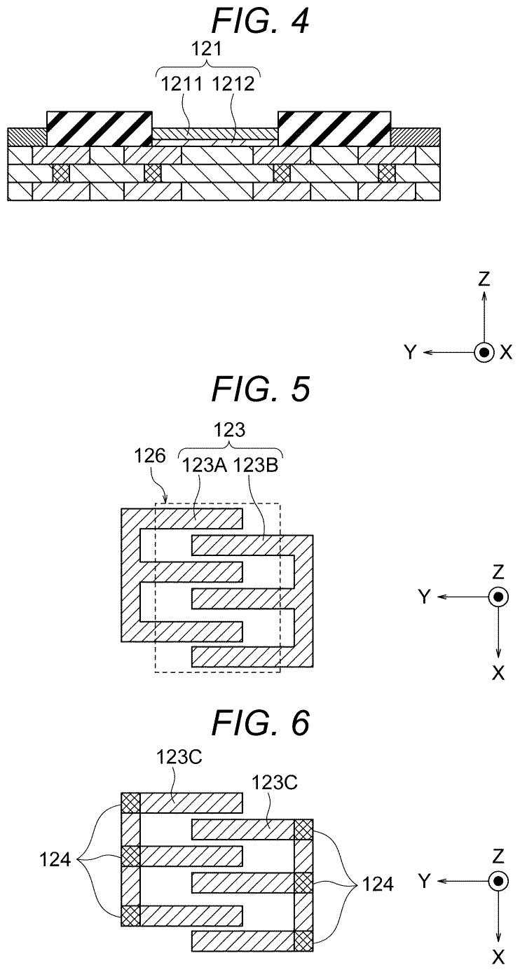

In the formation of the sensitive membranes 121, the technology disclosed in this non-patent document may be used. An example of this formation will be described with reference to FIG. 4. FIG. 4 is a schematic cross-sectional view illustrating a configuration example of the electrochemical sensor part 12 according to an embodiment of the present technology.

As illustrated in FIG. 4, the sensitive membrane 121 can be constituted by arranging an olfactory cell 1212 in a solvent 1211. Examples of the solvent 1211 include water, physiological saline, and a solid electrolyte.

Note that, in the present description, “odor component” may include any component that stimulates some or all of receptors present in the nasal cavity, such as odor molecules, among the above-described chemical substances. In the nasal cavity, besides olfactory receptors, for example, receptors of the trigeminal nerve that control stimulation such as cold, hot, and pain also exist, and the odor component in the present technology is a broad concept including all components that stimulate some or all of these receptors. Specifically, for example, in a case where menthol is used as an odor component, menthol can serve as a stimulus via an olfactory receptor as well as a cold stimulus via a receptor of the trigeminal nerve (transient receptor potential ankyrin 1 (TRPA1) channel).

### [(7) Configuration Example of Sensitive Membrane]

Depending on the type of the membrane, for example, the sensitivity, the required size of a contact surface in contact with the chemical substance, the required frequency of the AC signal, and the like, differ. Therefore, it is preferable to have a configuration in which the size of the contact surface or the membrane thickness can be changed for each sensitive membrane 121.

In order to implement this, as illustrated in FIGS. 2 and 3, the sensitive membranes 121 are separated from each other via an insulating membrane 122 in plan view. As a result, the type and the like of the membrane can be changed for each sensitive membrane 121. In addition, since the distance between sensitive membranes 121 can be shortened, the electrochemical sensor part 12 can be further miniaturized. Furthermore, for example, the size of the contact surface, the membrane thickness, the frequency of the AC signal, and the like can be changed according to the type of the sensitive membrane 121.

The insulating membrane 122 only needs to have an insulating property, and the type of the insulating membrane 122 is not particularly limited. The insulating membrane 122 may be formed with SiO₂ or the like contained, for example.

In addition, the types of the sensitive membranes 121 included in the two or more electrochemical sensor parts 12 may be different from each other. To describe by taking FIG. 2 as an example, the sensitive membranes 121A and 121D may be different in type from each other, and the sensitive membranes 121D and 121G may be the same in type. Alternatively, the sensitive membranes 121A, 121D, and 121G may be different in type from each other. Since the sensitive membranes 121 are different in type from each other, the circuit including the electrochemical sensor unit 1 can accurately identify a plurality of chemical substances in the sample.

Each sensitive membrane 121 has a contact surface in contact with a chemical substance. At this time, the contact surfaces included in the two or more electrochemical sensor parts 12 may be different in size from each other. To describe by taking FIG. 2 as an example, the size of the contact surface of the sensitive membrane 121A and the size of the contact surface of the sensitive membrane 121D may be different from each other, and the size of the contact surface of the sensitive membrane 121D and the size of the contact surface of the sensitive membrane 121G may be the same. Alternatively, the size of the contact surface of the sensitive membrane 121A, the size of the contact surface of the sensitive membrane 121D, and the size of the contact surface of the sensitive membrane 121G may be different from each other. Since the sizes of the contact surfaces are different from each other, the circuit including the electrochemical sensor unit 1 can accurately identify a plurality of chemical substances in the sample.

As described above, for example, the sensitivity, the required size of the contact surface, and the like are different depending on the type of the sensitive membrane. Therefore, the sizes of the contact surfaces may be different depending on the type of the sensitive membrane 121.

The frequencies of the AC signals to be input to the two or more electrochemical sensor parts 12 may be different from each other. To describe by taking FIG. 2 as an example, the AC signals to be input to the electrochemical sensor parts 12A and 12D may have frequencies different from each other, and the AC signals to be input to the electrochemical sensor parts 12D and 12G may have substantially the same frequencies. Alternatively, the AC signals to be input to the electrochemical sensor parts 12A, 12D, and 12G may have frequencies different from each other. Since the AC signals have frequencies different from each other, the circuit including the electrochemical sensor unit 1 can accurately identify a plurality of chemical substances in the sample.

As described above, for example, the AC signals have different frequencies depending on the type of the sensitive membrane, the size of the contact surface, or both of them. Therefore, the AC signals to be input to the two or more electrochemical sensor parts 12 may have different frequencies depending on at least one of the type or size of the sensitive membrane.

Although not illustrated, a support member that supports the sensitive membrane 121 may be formed on one surface (in particular a surface on an opposite side of the contact surface) of each sensitive membrane 121. In other words, the sensitive membrane 121 and the support member may be stacked.

The support member is preferably formed with a conductive material, and examples thereof include a silicon substrate and a metal substrate. Examples of the metal substrate include platinum (Pt), gold (Au), copper (Cu), palladium (Pd), nickel (Ni), and silver (Ag).

In order to form the support member on one surface of the sensitive membrane 121, a metal membrane can be formed by a conventionally known approach such as sputtering or a vapor synthesis method. The polymer membrane can be formed by a conventionally known approach such as chemical modification.

### [(8) Configuration Example of Electrode]

At least some of IQ electrodes 123A and AC electrodes 123B are arranged in contact with the sensitive membranes 121. The IQ electrode 123A is connected to the IQ conversion circuit 131 included in the response signal output circuit 13 via a via 124 and a wire line 125A. The AC electrode 123B is connected to the AC signal generation unit 11 via the via 124 and a wire line 125B. As a result, the AC signal from the AC signal generation unit 11 is input to the sensitive membrane 121 via the AC electrode 123B. Then, the response signal generated by the sensitive membrane 121 is input to the IQ conversion circuit 131 via the IQ electrode 123A.

The IQ electrode 123A and the AC electrode 123B are preferably arranged on an opposite side of the contact surface. As a result, it is possible to prevent the IQ electrode 123A and the AC electrode 123B from becoming obstacles and making it difficult for the chemical substance to come into contact with the sensitive membrane 121.

As the electrodes, for example, an electrode formed with a metal such as Pt, Au, Cu, Pd, Ni, or Ag, a diamond electrode, a boron-doped diamond (BDD) electrode, a carbon electrode, or the like can be used. The electrodes can be formed using a conventionally known approach such as a semi-additive method or a subtractive method.

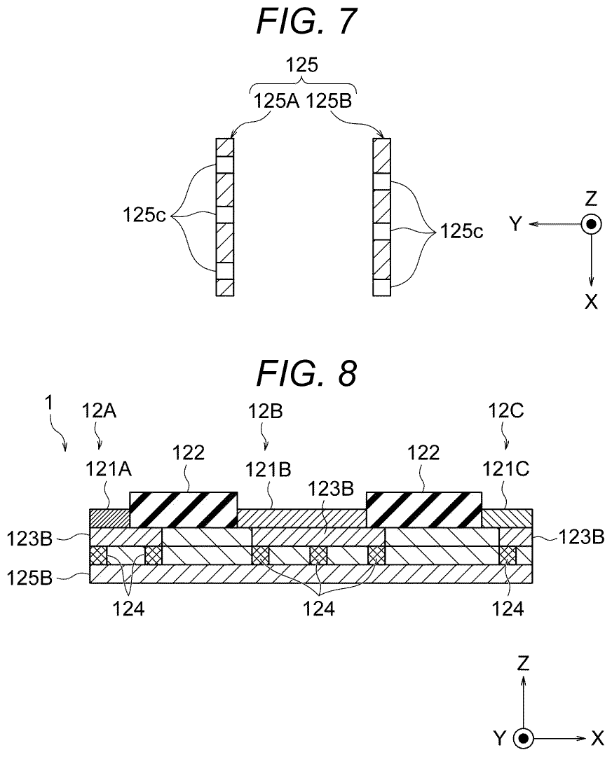

A configuration example of an electrode 123, the via 124, and the wire line 125 will be described with reference to FIGS. 5 to 7. FIGS. 5 to 7 are schematic plan views illustrating a configuration example of the electrochemical sensor part 12 according to an embodiment of the present technology. In specific description, FIG. 5 is a plan view of a layer in which the electrodes 123 are formed in FIG. 2. FIG. 6 is a plan view of a layer in which the vias 124 are formed in FIG. 2. FIG. 7 is a plan view of a layer in which the wire lines 125 are formed in FIG. 2.

In FIG. 5, the IQ electrode 123A and the AC electrode 123B are illustrated. In addition, a region 126 corresponding to an outer periphery of the contact surface of the sensitive membrane 121 is illustrated.

In FIG. 6, the vias 124 are illustrated. The via 124 electrically connects the electrode 123 and the wire line 125 to each other. Note that, in order to help understanding, regions 123C corresponding to regions in which the electrodes 123 are formed in FIG. 5 are illustrated. Actually, the electrodes 123 may not be formed in a layer in which the vias 124 are formed.

In FIG. 7, the wire lines 125 are illustrated. The wire line 125A is connected to the IQ conversion circuit 131 included in the response signal output circuit 13. The wire line 125B is connected to the AC signal generation unit 11. Note that, in order to help understanding, regions 125c corresponding to regions where the vias 124 are formed in FIG. 6 are illustrated.

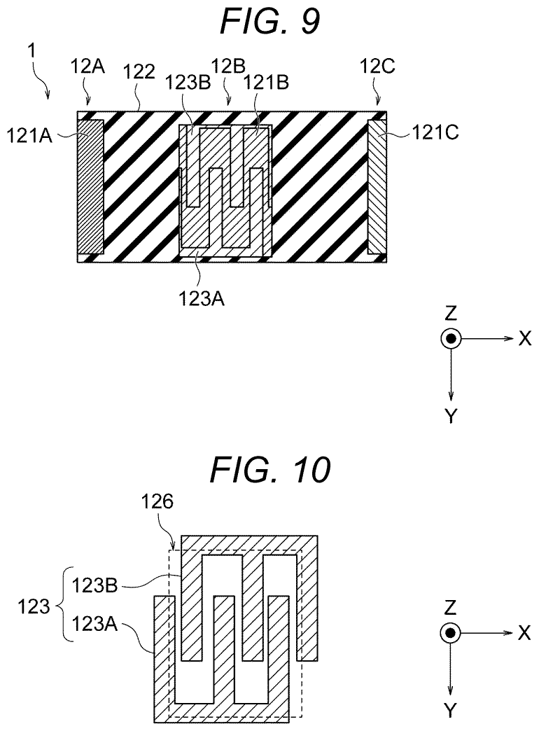

A configuration example of the electrochemical sensor part 12 will be further described with reference to FIGS. 8 and 9. FIG. 8 is a schematic cross-sectional view illustrating a configuration example of the electrochemical sensor part 12 according to an embodiment of the present technology. FIG. 9 is a schematic plan view illustrating a configuration example of the electrochemical sensor part 12 according to an embodiment of the present technology. In more detailed description, FIG. 8 is a cross-sectional view taken along a second cutting line (a cutting line passing through the electrochemical sensor parts 12A, 12B, and 12C) illustrated in FIG. 1. FIG. 9 is a plan view along this second cutting line.

FIGS. 8 and 9 illustrate the sensitive membranes 121A, 121B, and 121C, the electrode 123B, the vias 124, and the wire line 125B. The wire line 125B is connected to the AC signal generation unit 11.

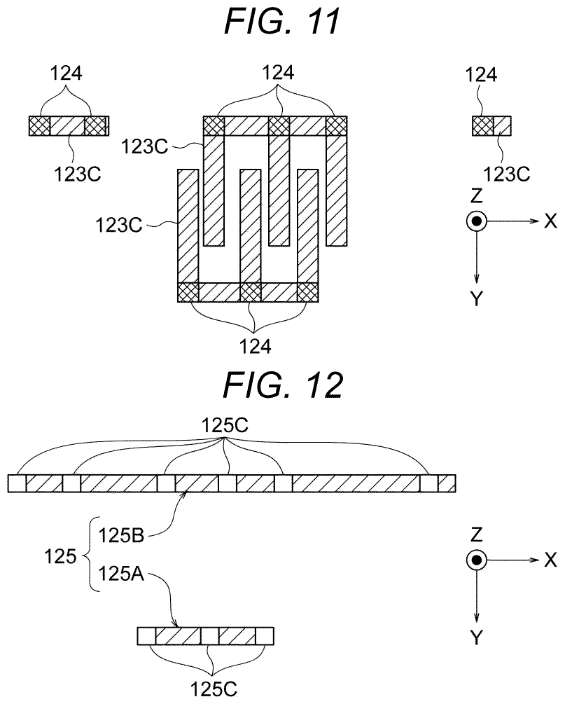

A configuration example of the electrode, the via, and the wire line will be described with reference to FIGS. 10 to 12. FIGS. 10 to 12 are schematic plan views illustrating a configuration example of the electrochemical sensor part 12 according to an embodiment of the present technology. In specific description, FIG. 10 is a plan view of a layer in which the electrode 123B is formed in FIG. 8. FIG. 11 is a plan view of a layer in which the vias 124 are formed in FIG. 8. FIG. 12 is a plan view of a layer in which the wire line 125B is formed in FIG. 8.

In FIG. 10, the IQ electrode 123A and the AC electrode 123B are illustrated. In addition, the region 126 corresponding to an outer periphery of the contact surface is illustrated.

In FIG. 11, the vias 124 are illustrated. The via 124 electrically connects the electrode 123 and the wire line 125 to each other. Note that, in order to help understanding, the regions 123C corresponding to regions where the electrodes 123 are formed in FIG. 10 are illustrated. Actually, the electrodes 123 may not be formed in a layer in which the vias 124 are formed.

In FIG. 12, the wire lines 125 are illustrated. The wire line 125A is connected to the IQ conversion circuit 131 included in the response signal output circuit 13. The wire line 125B is connected to the AC signal generation unit 11. Note that, in order to help understanding, the regions 125C corresponding to regions where the vias 124 are formed in FIG. 11 are illustrated.

The above content described for the electrochemical sensor unit according to the first embodiment of the present technology can be applied to other embodiments of the present technology unless otherwise technologically contradicted.

### 2. Second Embodiment of Present Technology (Example 2 of Electrochemical Sensor Unit)

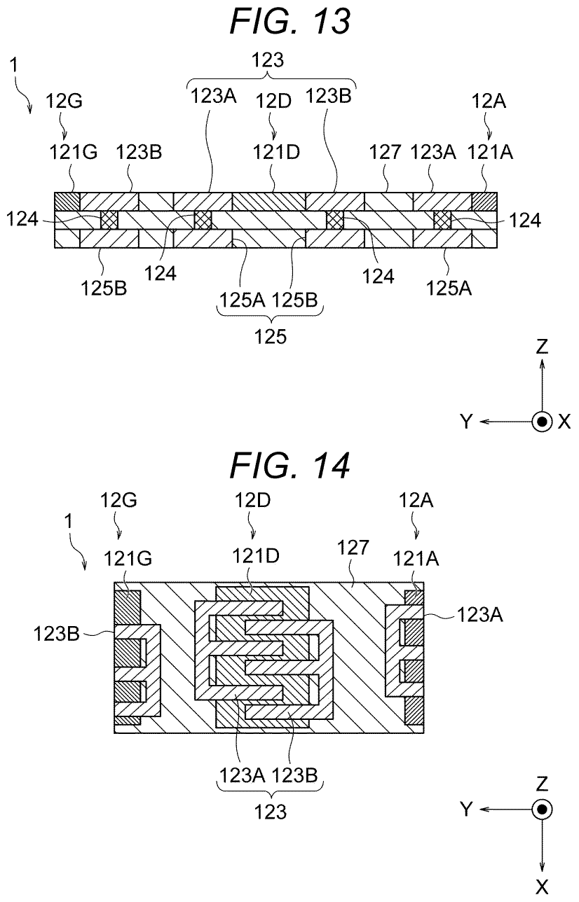

Another configuration example of an electrochemical sensor part 12 will be further described with reference to FIGS. 13 and 14. FIG. 13 is a schematic cross-sectional view illustrating a configuration example of the electrochemical sensor part 12 according to an embodiment of the present technology. FIG. 14 is a schematic plan view illustrating a configuration example of the electrochemical sensor part 12 according to an embodiment of the present technology. In more detailed description, FIG. 13 is a cross-sectional view taken along the first cutting line (a cutting line passing through the electrochemical sensor parts 12A, 12D, and 12G) illustrated in FIG. 1. FIG. 14 is a plan view along this first cutting line.

As illustrated in FIGS. 13 and 14, the electrochemical sensor parts 12A, 12D, and 12G have sensitive membranes 121A, 121D, and 121G having physical properties that change in response to a chemical substance in a sample, respectively.

Then, in plan view, the sensitive membranes 121A, 121D, and 121G are separated from each other via electrodes 123. In other words, in the configuration example illustrated in FIGS. 2 and 3, the sensitive membranes 121A, 121D, and 121G are separated from each other via the insulating membrane 122. Meanwhile, in the configuration examples illustrated in FIGS. 13 and 14, the sensitive membranes 121A, 121D, and 121G are separated from each other via the electrodes 123.

As a result, the type and the like of the membrane can be changed for each sensitive membrane 121. In addition, since the distance between sensitive membranes 121 can be shortened, the electrochemical sensor part 12 can be further miniaturized. Furthermore, for example, the size of the contact surface, the membrane thickness, the frequency of the AC signal, and the like can be changed according to the type of the sensitive membrane 121.

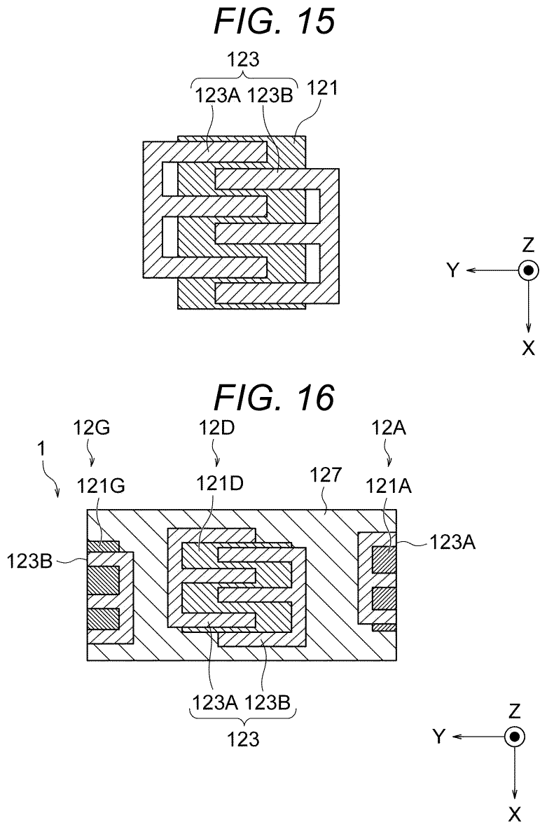

A configuration example of the sensitive membrane 121 and the electrode 123 will be described with reference to FIG. 15. FIG. 15 is a schematic plan view illustrating a configuration example of the electrochemical sensor part 12 according to an embodiment of the present technology. In specific description, FIG. 15 is a plan view of a layer in which the electrodes 123 and the sensitive membranes 121 are formed in FIG. 13.

In FIG. 15, an IQ electrode 123A and an AC electrode 123B are illustrated. The sensitive membrane 121 is formed in each gap between the IQ electrode 123A and the AC electrode 123B.

Note that configuration examples of a via 124 and a wire line 125 are similar to those in FIGS. 6 and 7, and thus, description thereof will be omitted.

The arrangement of the sensitive membranes 121 and the electrodes 123 is not limited thereto. For example, the sensitive membranes 121 and the electrodes 123 may be arranged as illustrated in FIG. 16. FIG. 16 is a schematic plan view illustrating a configuration example of the electrochemical sensor part 12 according to an embodiment of the present technology. As illustrated in FIG. 16, a part of an end of each of the sensitive membranes 121A, 121D, and 121G may be arranged surrounded by parts of the electrodes 123.

The above content described for the electrochemical sensor unit according to the second embodiment of the present technology can be applied to other embodiments of the present technology unless otherwise technologically contradicted.

### 3. Third Embodiment of Present Technology (Example 3 of Electrochemical Sensor Unit)

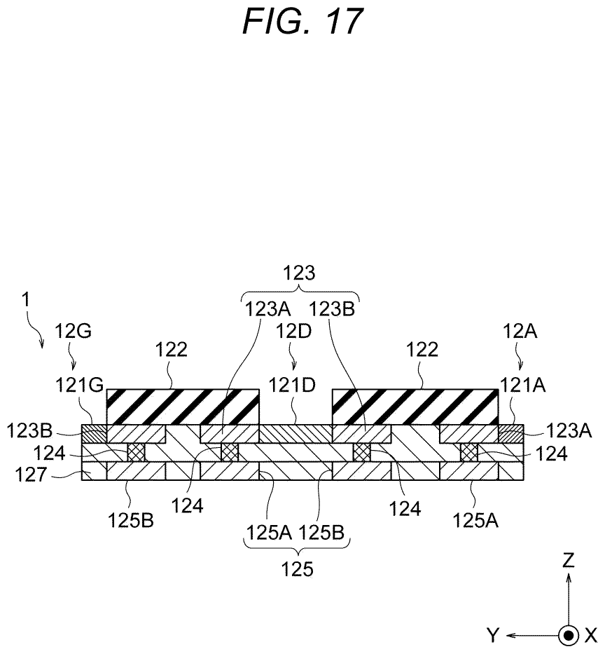

Another configuration example of an electrochemical sensor part 12 will be further described with reference to FIG. 17. FIG. 17 is a schematic cross-sectional view illustrating a configuration example of the electrochemical sensor part 12 according to an embodiment of the present technology. In more detailed description, FIG. 17 is a cross-sectional view taken along the first cutting line (a cutting line passing through the electrochemical sensor parts 12A, 12D, and 12G) illustrated in FIG. 1.

As illustrated in FIG. 17, the electrochemical sensor parts 12A, 12D, and 12G have sensitive membranes 121A, 121D, and 121G having physical properties that change in response to a chemical substance in a sample, respectively.

Then, in plan view, the sensitive membranes 121A, 121D, and 121G are separated from each other via an insulating membrane 122 and electrodes 123. In other words, in the configuration example illustrated in FIG. 2, the sensitive membranes 121A, 121D, and 121G are separated from each other via the insulating membrane 122. In the configuration example illustrated in FIG. 13, the sensitive membranes 121A, 121D, and 121G are separated from each other via the electrodes 123. Meanwhile, in the configuration example illustrated in FIG. 17, the sensitive membranes 121A, 121D, and 121G are separated from each other via the insulating membrane 122 and the electrodes 123.

As a result, the type and the like of the membrane can be changed for each sensitive membrane 121. In addition, since the distance between sensitive membranes 121 can be shortened, the electrochemical sensor part 12 can be further miniaturized. Furthermore, for example, the size of the contact surface, the membrane thickness, the frequency of the AC signal, and the like can be changed according to the type of the sensitive membrane 121.

The above content described for the electrochemical sensor unit according to the third embodiment of the present technology can be applied to other embodiments of the present technology unless otherwise technologically contradicted.

### 4. Fourth Embodiment of Present Technology (Example 4 of Electrochemical Sensor Unit)

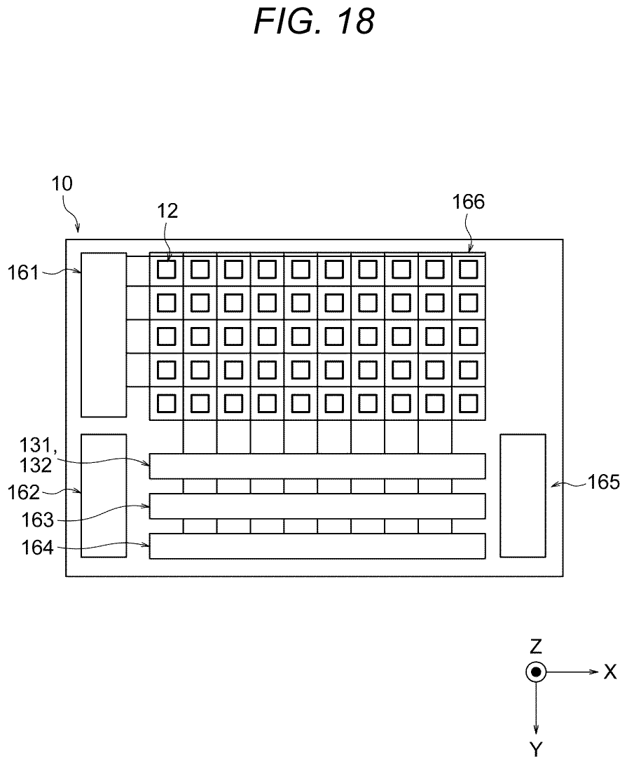

FIG. 18 is a block diagram illustrating a configuration example of an apparatus 10 including an electrochemical sensor part 12 according to an embodiment of the present technology. As illustrated in FIG. 18, the apparatus 10 includes a vertical drive unit 161, a system control unit 162, a pixel array unit 166, a response signal output circuit including an IQ conversion circuit 131 and an AD conversion circuit 132, a data storage unit 163, a horizontal drive unit 164, and a signal processing unit 165. A conventionally known technology can be used for each constituent element.

At least some of the electrochemical sensor parts 12 are arranged in an array in the pixel array unit 166. That is, in the pixel array unit 166, the electrochemical sensor parts 12 that are pixels are arranged in a matrix (two-dimensionally) in a row direction and a column direction.

Here, the row direction is an X-axis direction and indicates an array direction (so-called horizontal direction) of each pixel 12 in pixel rows. The column direction is a Y-axis direction and indicates an array direction (so-called vertical direction) of each pixel 12 in pixel columns. In the following, the row direction may be sometimes described as the horizontal direction, and the column direction may be sometimes described as the vertical direction.

In the pixel array unit 166, pixel drive lines are wired for each pixel row along the row direction in a matrix pixel array. In addition, vertical signal lines are wired for each pixel column along the column direction. The pixel drive lines transmit drive signals for driving the pixels 12 in order to read signals from the pixels 12. The number of pixel drive lines is not restricted to one.

Each of two or more electrochemical sensor parts 12 is connected to one IQ conversion circuit 131. With such a configuration, layout efficiency can be enhanced, and an entire area of the apparatus 10 can be reduced.

Hereinafter, each circuit unit of a peripheral circuit unit of the pixel array unit 166, that is, the vertical drive unit 161, the AD conversion circuit 132, the data storage unit 163, the horizontal drive unit 164, and the signal processing unit 165 will be described.

The vertical drive unit 161 is constituted by a shift register, an address decoder, and the like and drives each pixel 12 of the pixel array unit 166 in units of rows, or the like. Each pixel 12 of the pixel array unit 166 is selected in units of pixel rows by the vertical drive unit 161, whereby the response signals are read from each pixel 12 in the selected pixel row.

To each pixel 12 of the pixel row selectively scanned by the vertical drive unit 161, a bias current is supplied through each of the vertical signal lines from a current source (not illustrated) including a metal oxide semiconductor (MOS) field-effect transistor connected to each of the vertical signal lines for each pixel column. Pixel signals read from each pixel 12 of the pixel array unit 166 in units of pixel rows are supplied to the AD conversion circuit 132 through each of the vertical signal lines.

The AD conversion circuit 132 includes a set of a plurality of analog-digital converters (ADC) provided corresponding to the respective vertical signal lines and converts the analog pixel signals output in units of pixel rows, for each pixel column into digital signals. That is, the AD conversion circuit 132 is a column-parallel type analog-digital conversion unit formed by arranging a plurality of analog-digital converters in parallel corresponding to the pixel columns.

As the analog-digital converter, a well-known analog-digital converter can be used. Specifically, a single-slope analog-digital converter that is an example of a reference signal comparison type analog-digital converter, a successive approximation analog-digital converter, or a delta-sigma modulation type (42 modulation type) analog-digital converter can be exemplified as the analog-digital converter. However, the analog-digital converter are not limited to these.

In the AD conversion circuit 132, the analog-digital converters can be arranged in a one-to-one relationship with respect to the pixel columns, that is, for each pixel column in one configuration, or one analog-digital converter can be arranged for a plurality of pixel columns in another configuration.

The data storage unit 163 is disposed at a subsequent stage of the AD conversion circuit 132. The data storage unit 163 includes a set of a plurality of latch circuits provided corresponding to the respective vertical signal lines and latches the response signals after analog-digital conversion during a period for reading the response signals from each pixel 12 of the pixel array unit 166.

The response signals for one row latched in each latch circuit of the data storage unit 163 are supplied to the signal processing unit 165, and predetermined processing is performed in the signal processing unit 165.

The apparatus 10 having the above configuration example can have a flat structure or a stacked structure as a chip structure including a single chip.

The flat structure is a chip structure in which the peripheral circuit unit of the pixel array unit 166 is formed on the same semiconductor substrate (semiconductor chip) as the pixel array unit 166. That is, in the flat structure, the vertical drive unit 161, the AD conversion circuit 132, the data storage unit 163, the horizontal drive unit 164, the signal processing unit 165, and the like are formed on the same semiconductor substrate as the pixel array unit 166.

The stacked structure is a chip structure in which the peripheral circuit unit of the pixel array unit 166 is formed on at least one semiconductor substrate different from the semiconductor substrate on which the pixel array unit 166 is formed. In the apparatus 10 having this stacked structure, the first-layer semiconductor substrate is only required to have the dimensions (area) enough to allow the pixel array unit 166 to be formed, and thus the size (area) of the first-layer semiconductor substrate and eventually the size of an entire chip can be lessened. Furthermore, a process suitable for producing the pixels 12 can be applied to the first-layer semiconductor substrate, and a process suitable for producing the circuit portion can be applied to other semiconductor substrates. Therefore, the process can be optimized in manufacturing the apparatus 10.

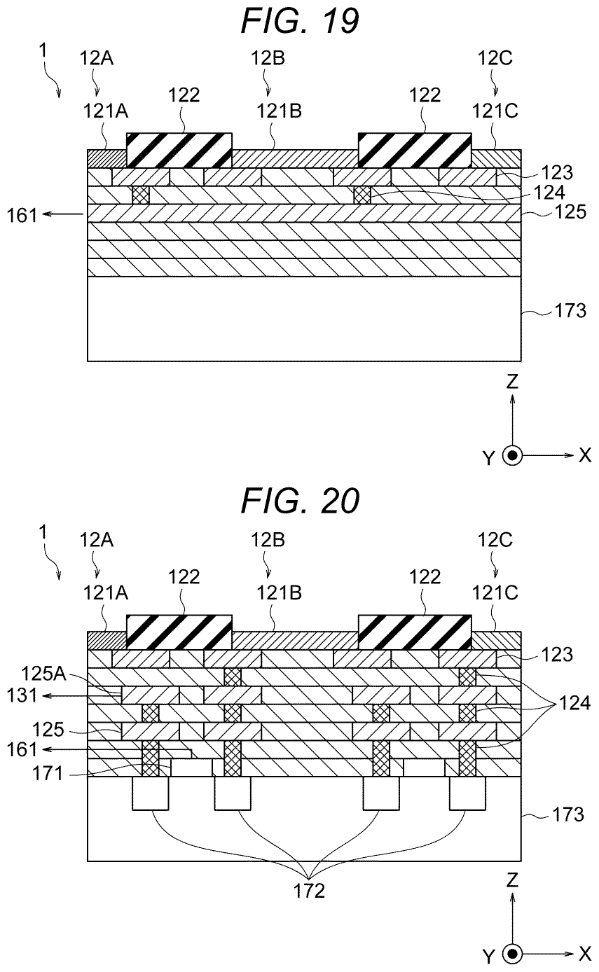

A configuration example of the electrochemical sensor part 12 at this time will be described with reference to FIGS. 19 and 20. FIGS. 19 and 20 are schematic cross-sectional views illustrating a configuration example of the electrochemical sensor part 12 according to an embodiment of the present technology.

As illustrated in FIG. 19, the electrochemical sensor parts 12A, 12B, and 12C are formed on one surface of a semiconductor substrate 173. The semiconductor substrate 173 can be a semiconductor substrate of a first conductivity type (for example, n-type) formed with silicon or the like, for example.

The sensitive membranes 121A, 121B, and 121C included in the electrochemical sensor parts 12A, 12B, and 12C are connected to wire lines 125 via electrodes 123 and vias 124. These wire lines 125 are connected to the vertical drive unit 161.

In addition, as illustrated in FIG. 20, transistors 172 that can be a region of the first conductivity type are formed along one surface of the semiconductor substrate 173.

A gate electrode 171 may be formed on one surface of the semiconductor substrate 173 via an insulating protective membrane (not illustrated). The gate electrode 171 is connected to the vertical drive unit 161. As the protective membrane, for example, SiO₂ or the like can be used.

Furthermore, the sensitive membranes 121A, 121B, and 121C included in the electrochemical sensor parts 12A, 12B, and 12C are connected to the transistors 172 via the electrodes 123, the vias 124, and the wire lines 125. The wire line 125A may be connected to the IQ conversion circuit 131.

The above content described for the electrochemical sensor unit according to the fourth embodiment of the present technology can be applied to other embodiments of the present technology unless otherwise technologically contradicted.

### 5. Fifth Embodiment of Present Technology (Example 5 of Electrochemical Sensor Unit)

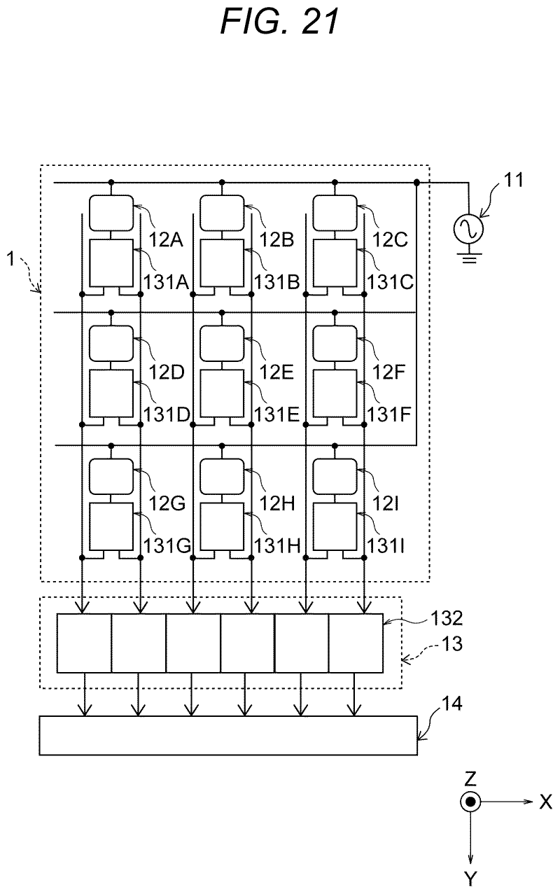

In the configuration example illustrated in FIGS. 1 and 18, each of the two or more electrochemical sensor parts 12 is connected to one IQ conversion circuit 131. Meanwhile, one electrochemical sensor part 12 may be connected to one IQ conversion circuit 131. This point will be described with reference to FIG. 21. FIG. 21 is a circuit diagram illustrating a configuration example of a circuit including an electrochemical sensor unit 1 according to an embodiment of the present technology.

As illustrated in FIG. 21, one electrochemical sensor part 12 is connected to one IQ conversion circuit 131. For example, an electrochemical sensor part 12A is connected to an IQ conversion circuit 131A.

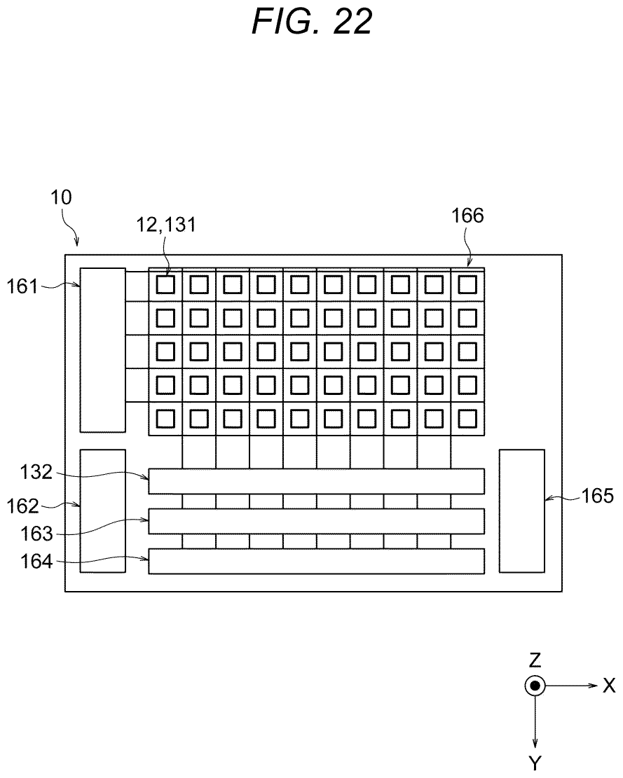

This configuration example of an apparatus 10 including the electrochemical sensor part 12 will be described with reference to FIG. 22. FIG. 22 is a block diagram illustrating a configuration example of the apparatus 10 including the electrochemical sensor part 12 according to an embodiment of the present technology. As illustrated in FIG. 22, the apparatus 10 includes a vertical drive unit 161, a system control unit 162, a pixel array unit 166 including the IQ conversion circuit 131, a response signal output circuit including an AD conversion circuit 132, a data storage unit 163, a horizontal drive unit 164, and a signal processing unit 165. A conventionally known technology can be used for each constituent element.

At least some of the electrochemical sensor parts 12 are arranged in an array in the pixel array unit 166. One electrochemical sensor part 12 and one IQ conversion circuit 131 are connected to each other to constitute one pixel.

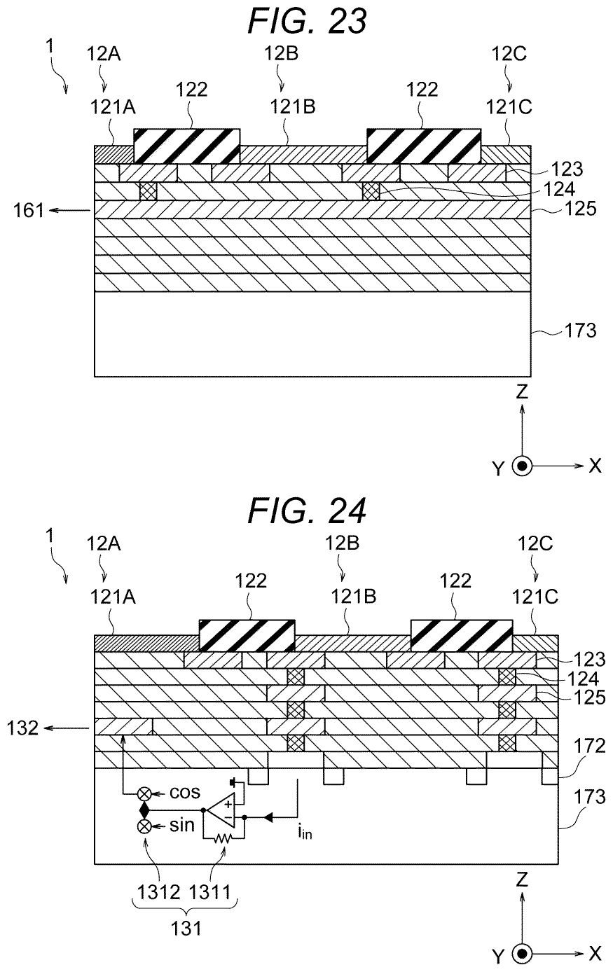

A configuration example of the electrochemical sensor part 12 at this time will be described with reference to FIGS. 23 and 24. FIGS. 23 and 24 are schematic cross-sectional views illustrating a configuration example of the electrochemical sensor part 12 according to an embodiment of the present technology.

As illustrated in FIG. 23, the electrochemical sensor parts 12A, 12B, and 12C are formed on one surface of a semiconductor substrate 173. The semiconductor substrate 173 can be a semiconductor substrate of the first conductivity type (for example, n-type) formed with silicon or the like, for example.

The sensitive membranes 121A, 121B, and 121C included in the electrochemical sensor parts 12A, 12B, and 12C are connected to wire lines 125 via electrodes 123 and vias 124. These wire lines 125 may be connected to the vertical drive unit 161.

In addition, as illustrated in FIG. 24, transistors 172 that can be a region of the first conductivity type are formed along one surface of the semiconductor substrate 173.

The sensitive membranes 121A, 121B, and 121C included in the electrochemical sensor parts 12A, 12B, and 12C are connected to the semiconductor substrate 173 via the electrodes 123, the vias 124, and the wire lines 125. Alternating currents iin output from the sensitive membranes 121A, 121B, and 121C via the electrodes 123, the vias 124, and the wire lines 125 are output to the IQ conversion circuits 131.

The IQ conversion circuit 131 may include, for example, a transimpedance amplifier (TIA) 13111 and an analog multiplier 1312.

The TIA 1311 converts the alternating current iin output from the electrochemical sensor part 12 into a voltage signal. The converted voltage signal is calculated at high speed by the analog multiplier 1312. The analog multiplier 1312 is not particularly limited, and a conventionally known analog multiplier can be used. Specific examples of the analog multiplier include a commonly used Gilbert cell-type analog multiplier.

Although not illustrated, the IQ conversion circuit 131 may further include a low-pass filter (LPF). The LPF extracts a direct current (DC) component from a calculation result of the analog multiplier. The direct current components of the I signal and the Q signal are correlated with the real component and the imaginary component of the input signal. Therefore, an amplitude and a phase in the above-described electrochemical sensor part 12 can be computed, which results in making it possible to compute impedance at a measurement point. Specific examples of the LPF include a repetitive current (RC) low-pass filter.

The signal output from the IQ conversion circuit 131 is supplied to the AD conversion circuit 132 via the wire line 125.

The above content described for the electrochemical sensor unit according to the fifth embodiment of the present technology can be applied to other embodiments of the present technology unless otherwise technologically contradicted.

### 6. Sixth Embodiment of Present Technology (Example 6 of Electrochemical Sensor Unit)

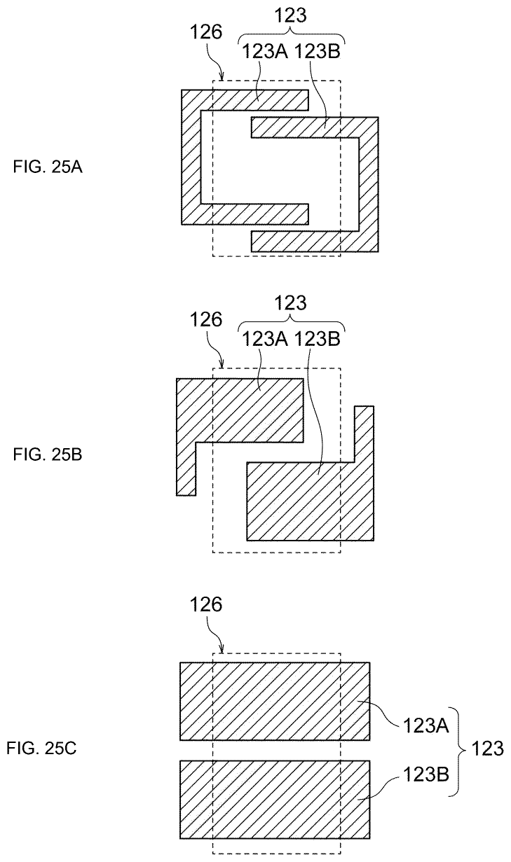

The shape of each of the IQ electrode 123A and the AC electrode 123B is not limited to the above-described embodiments. Each of the IQ electrode 123A and the AC electrode 123B may be in contact with the sensitive membrane An example of the shape of each of the IQ electrode 123A and the AC electrode 123B will be described with reference to FIG. 25. FIG. 25 is a schematic plan view illustrating an example of shapes of an electrode 123 according to an embodiment of the present technology.

In FIG. 25, a region 126 corresponding to an outer periphery of the contact surface in contact with a chemical substance in a sensitive membrane 121 is illustrated.

As illustrated in FIG. 25A, the shape of each of the IQ electrode 123A and the AC electrode 123B may be an alphabet C shape in plan view, and an end thereof may be in contact with the sensitive membrane 121.

As illustrated in FIG. 25B, the shape of each of the IQ electrode 123A and the AC electrode 123B may be an alphabet P shape in plan view, having a shape in which an end thereof is in contact with the sensitive membrane 121.

As illustrated in FIG. 25C, the shape of each of the IQ electrode 123A and the AC electrode 123B may be a rectangle in plan view, and almost an entire surface thereof may be in contact with the sensitive membrane 121. For example, the rectangle includes a square, an oblong rectangle, a square with rounded corners, and an oblong rectangle with rounded corners.

The shape of each of the IQ electrode 123A and the AC electrode 123B is not restricted to the shapes illustrated in FIG. 25. The shape of each of the IQ electrode 123A and the AC electrode 123B may be, for example, a polygon such as a triangle, a pentagon, or a hexagon. In addition, the shapes of the IQ electrode 123A and the AC electrode 123B may be different from each other.

However, it is preferable that an area where the IQ electrode 123A and the sensitive membrane 121 are in contact with each other and an area where the AC electrode 123B and the sensitive membrane 121 are in contact with each other are substantially the same. As a result, rise of bias in the AC signal applied to the electrochemical sensor part 12 and the response signal generated by the electrochemical sensor part 12 can be suppressed.

The above content described for the electrochemical sensor unit according to the sixth embodiment of the present technology can be applied to other embodiments of the present technology unless otherwise technologically contradicted.

### 7. Seventh Embodiment of Present Technology (Example of Odor Component Electrochemical Sensor Unit)

The present technology provides an odor component electrochemical sensor unit including two or more electrochemical sensor parts 12 each connected to one AC signal generation unit 11, in which each of the electrochemical sensor parts 12 includes a sensitive membrane 121 having a physical property that changes in response to an odor component in a sample, and the sensitive membranes 121 are separated from each other via at least one of an insulating membrane 122 or an electrode 123 in plan view.

That is, the electrochemical sensor unit described above is applied to odor component identification. The configuration of the electrochemical sensor unit for odor component identification is similar to that described above, and thus, the description thereof will not be given here.

In the present description, “odor component” can include any component that stimulates some or all of receptors present in the nasal cavity, among the above-described chemical substances. In the nasal cavity, besides olfactory receptors, for example, receptors of the trigeminal nerve that control stimulation such as cold, hot, and pain also exist, and the odor component in the present technology is a broad concept including all components that stimulate some or all of these receptors. Specifically, for example, in a case where menthol is used as an odor component, menthol can serve as a stimulus via an olfactory receptor as well as a cold stimulus via a receptor of the trigeminal nerve (TRPA1 channel).

Note that the odor component includes, apart from those that can be recognized as an odor by a human, those that are not allowed to be recognized by a human as an odor but have some action on a human by being sucked. For example, a medical sedative to be sucked, a gas that is odorless but acts on the physical condition of a human by being sucked, as represented by oxygen or carbon dioxide, or the like is also included in the odor component.

The above content described for the odor component electrochemical sensor unit according to the seventh embodiment of the present technology can be applied to other embodiments of the present technology unless otherwise technologically contradicted.

### 8. Eighth Embodiment of Present Technology (Example 1 of Method for Manufacturing Electrochemical Sensor Unit)

The present technology provides a method for manufacturing an electrochemical sensor unit, including: forming sensitive membranes having a physical property that changes in response to a chemical substance in a sample; and separating the sensitive membranes from each other via at least one of an insulating membrane or an electrode in plan view.

In the manufacture of an electric sensor unit according to an embodiment of the present technology, for example, a conventionally known photolithography technology and a conventionally known dry etching technology or wet etching technology can be combined.

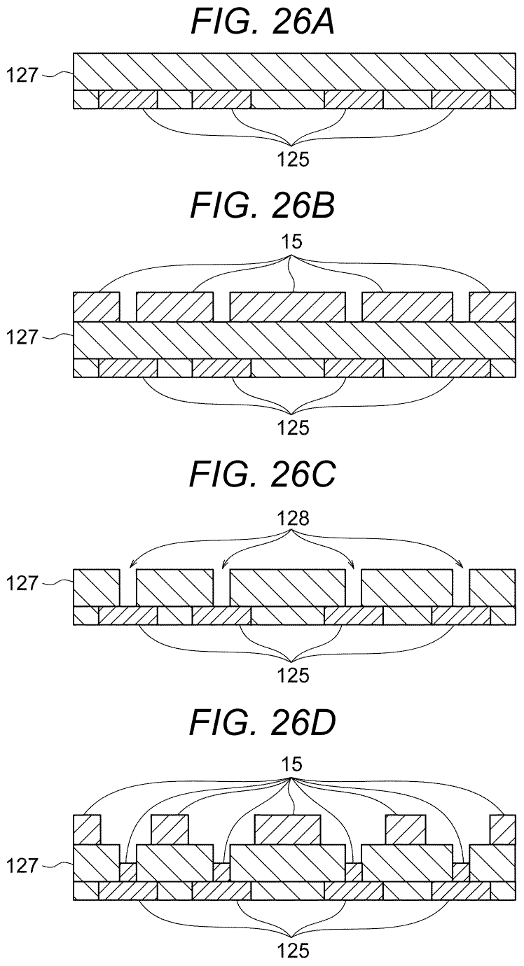

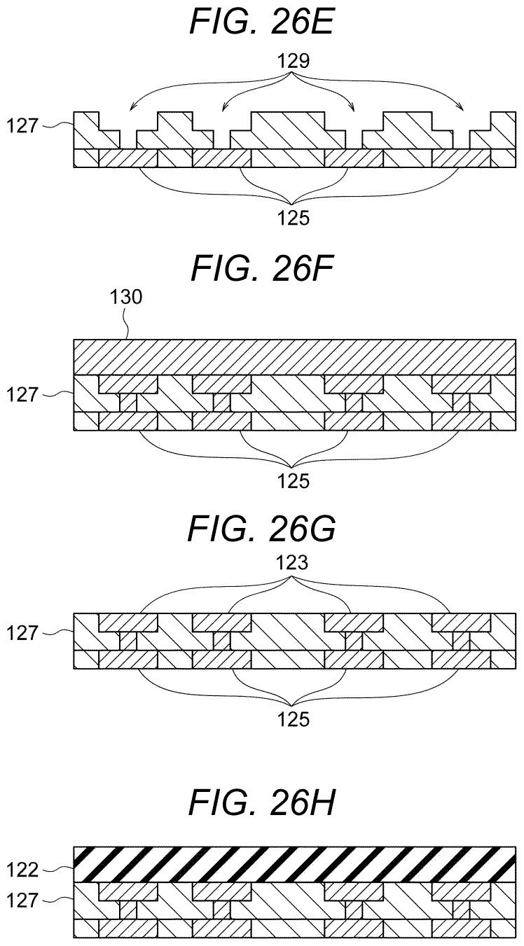

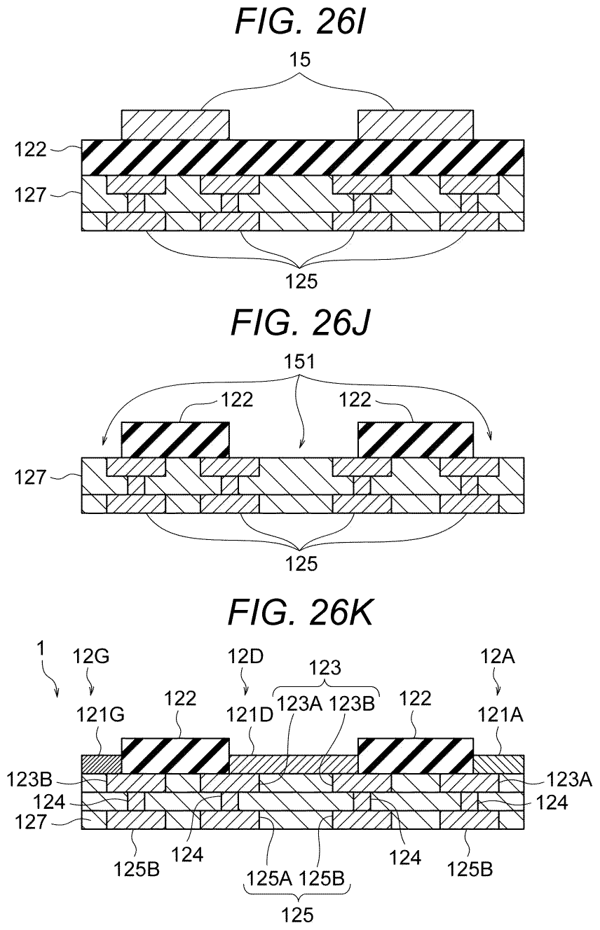

An example of a method for manufacturing the electric sensor unit illustrated in FIG. 2 will be described with reference to FIGS. 26A to 26K. FIGS. 26A to 26K are schematic cross-sectional views for explaining the method for manufacturing the electric sensor unit according to an embodiment of the present technology.

First, as illustrated in FIG. 26A, a photoresist 127 is applied to one surface of a layer in which the wire lines 125 are formed. The photoresist is a composition having physical properties such as solubility change in response to light, an electron beam, or the like.

Next, as illustrated in FIG. 26B, a photomask 15 is arranged and irradiated with light from above in the drawing. Then, a portion where the photomask 15 is not arranged is irradiated with light. The solubility of the photoresist 127 changes only in a portion irradiated with light.

Next, as illustrated in FIG. 26C, the photoresist in a portion where the solubility has changed is removed, and for example, dry etching is performed. As a result, openings 128 are formed. Note that vias are formed in these openings 128 in a later step.

Next, as illustrated in FIG. 26D, the photomask 15 is arranged and irradiated with light from above in the drawing. Then, a portion where the photomask 15 is not arranged is irradiated with light. The solubility of the photoresist 127 changes only in a portion irradiated with light.

Next, as illustrated in FIG. 26E, the photoresist in a portion where the solubility has changed is removed, and for example, dry etching is performed. As a result, openings 129 are formed. Note that electrodes are formed in these openings 129 in a later step.

Next, as illustrated in FIG. 26F, a metal material 130 is deposited as a membrane. Note that this metal material becomes the electrodes and the vias in a later step.

Next, as illustrated in FIG. 26G, the surface is polished by, for example, chemical mechanical polishing (CMP). As a result, the electrodes 123 are formed.

Next, as illustrated in FIG. 26H, the insulating membrane 122 is formed.

Next, as illustrated in FIG. 26I, the photomask 15 is arranged and irradiated with light from above in the drawing. Then, a portion where the photomask 15 is not arranged is irradiated with light. The solubility of the insulating membrane 122 changes only in a portion irradiated with light.

Next, as illustrated in FIG. 26J, the insulating membrane in a portion where the solubility has changed is removed, and for example, dry etching is performed. As a result, openings 151 are formed. Note that sensitive membranes are formed in these openings 151 in a later step.

Finally, as illustrated in FIG. 26K, the sensitive membranes 121A, 121D, and 121G having physical properties that change in response to a chemical substance in a sample are applied to the openings 151. The sensitive membranes 121A, 121D, and 121G are separated from each other via the insulating membrane 122. In order to make the types of the sensitive membranes 121A, 121D, and 121G different from each other, for example, the sensitive membranes can be applied by a technology such as inkjet or dispenser.

The above content described for the method for manufacturing the electrochemical sensor unit according to the eighth embodiment of the present technology can be applied to other embodiments of the present technology unless otherwise technologically contradicted.

### 9. Ninth Embodiment of Present Technology (Example 2 of Method for Manufacturing Electrochemical Sensor Unit)

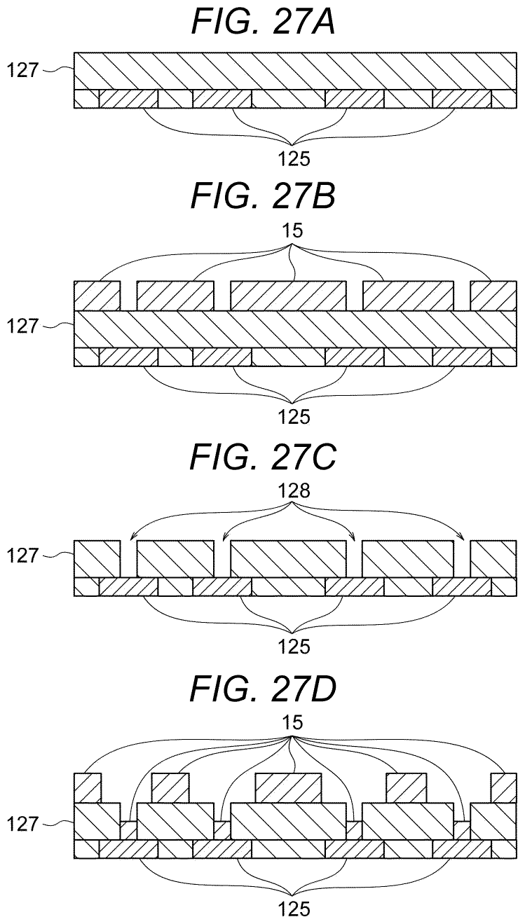

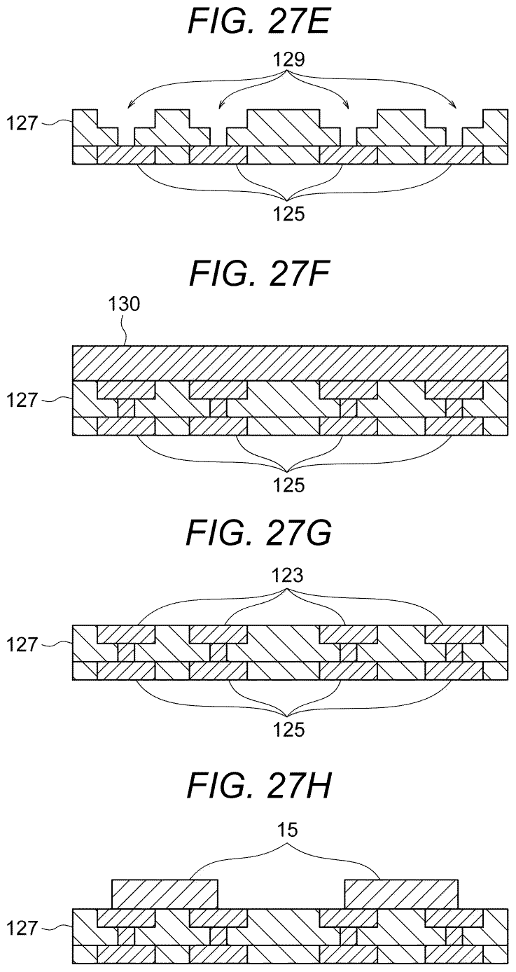

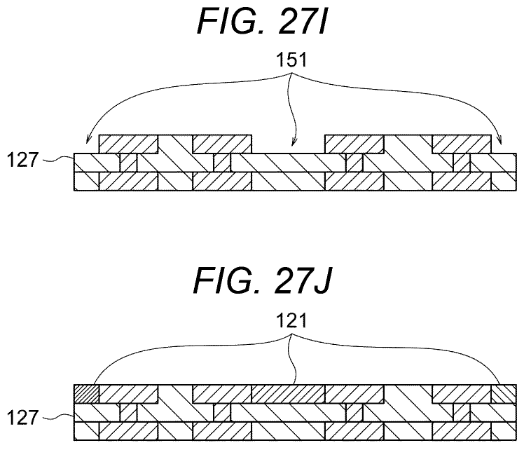

An example of a method for manufacturing an electric sensor unit illustrated in FIG. 13 will be described with reference to FIGS. 27A to 27J. FIGS. 27A to 27J are schematic cross-sectional views for explaining the method for manufacturing the electric sensor unit according to an embodiment of the present technology.

First, as illustrated in FIG. 27A, a photoresist 127 is applied to one surface of a layer in which the wire lines 125 are formed.

Next, as illustrated in FIG. 27B, a photomask 15 is arranged and irradiated with light from above in the drawing. Then, a portion where the photomask 15 is not arranged is irradiated with light. The solubility of the photoresist 127 changes only in a portion irradiated with light.

Next, as illustrated in FIG. 27C, the photoresist in a portion where the solubility has changed is removed, and for example, dry etching is performed. As a result, openings 128 are formed. Note that vias are formed in these openings 128 in a later step.

Next, as illustrated in FIG. 27D, the photomask 15 is arranged and irradiated with light from above in the drawing. Then, a portion where the photomask 15 is not arranged is irradiated with light. The solubility of the photoresist 127 changes only in a portion irradiated with light.

Next, as illustrated in FIG. 27E, the photoresist in a portion where the solubility has changed is removed, and for example, dry etching is performed. As a result, openings 129 are formed. Note that electrodes and vias are formed in these openings 129 in a later step. Next, as illustrated in FIG. 27F, a metal material 130 is deposited as a membrane. Note that this metal material becomes the electrodes and the vias in a later step.

Next, as illustrated in FIG. 27G, the surface is polished by, for example, chemical mechanical polishing (CMP). As a result, the electrodes 123 and the vias are formed.

Next, as illustrated in FIG. 27H, the photomask 15 is arranged and irradiated with light from above in the drawing. Then, a portion where the photomask 15 is not arranged is irradiated with light. The solubility of the photoresist 127 changes only in a portion irradiated with light.

Next, as illustrated in FIG. 27I, the photoresist in a portion where the solubility has changed is removed, and for example, dry etching is performed. At this time, it is preferable to apply a condition that the selection ratio of the insulating membrane/metal material is high and the insulating membrane is preferentially etched. As a result, openings 151 are formed. Note that sensitive membranes are formed in these openings 151 in a later step.

Finally, as illustrated in FIG. 27J, the sensitive membranes 121 having physical properties that change in response to a chemical substance in a sample are formed in the openings 151. The sensitive membranes 121 are separated from each other via the electrodes 123. In order to make the types of the sensitive membranes 121 different from each other, for example, the sensitive membranes can be applied by a technology such as inkjet or dispenser.

The above content described for the method for manufacturing the electrochemical sensor unit according to the ninth embodiment of the present technology can be applied to other embodiments of the present technology unless otherwise technologically contradicted.

Note that the present technology can also adopt the following configurations.

[1]

An electrochemical sensor unit including
two or more electrochemical sensor parts each connected to one alternating current (AC) signal generation unit, in which
each of the electrochemical sensor parts includes a sensitive membrane having a physical property that changes in response to a chemical substance in a sample, and
the sensitive membranes are separated from each other via at least one of an insulating membrane or an electrode in plan view.
   [2]

The electrochemical sensor unit according to [1], in which
at least some of the electrochemical sensor parts are arranged in an array.
   [3]

The electrochemical sensor unit according to [1] or [2], in which
types of the sensitive membranes included in two or more of the electrochemical sensor parts are different from each other.
   [4]

The electrochemical sensor unit according to any one of [1] to [3], in which
the sensitive membrane has a contact surface in contact with the chemical substance, and
the contact surfaces included in two or more of the electrochemical sensor parts each have a different size.
   [5]

The electrochemical sensor unit according to [4], in which
sizes of the contact surfaces are different depending on the types of the sensitive membranes.
   [6]

The electrochemical sensor unit according to any one of [1] to [5], in which
frequencies of the AC signal generation unit to be input to two or more of the electrochemical sensor parts are different from each other.
   [7]

The electrochemical sensor unit according to any one of [3] to [6], in which
frequencies of the AC signal generation unit to be input to two or more of the electrochemical sensor parts are different depending on at least one of the types or sizes of the sensitive membranes.
   [8]

The electrochemical sensor unit according to any one of [1] to [7], further including
one or more response signal output circuits that output response signals from the electrochemical sensor parts, in which
at least some of the response signal output circuits include an in-phase/quadrature-phase (IQ) conversion circuit, and
at least some of the electrodes include an IQ electrode connected to the IQ conversion circuit and an AC electrode connected to the AC signal generation unit.
   [9]

The electrochemical sensor unit according to [8], in which
the sensitive membrane has a contact surface in contact with the chemical substance, and
the IQ electrode and the AC electrode are arranged on an opposite side of the contact surface.
   [10]

The electrochemical sensor unit according to [8] or [9], in which
an area where the IQ electrode and the sensitive membrane are in contact with each other and an area where the AC electrode and the sensitive membrane are in contact with each other are substantially same.
   [11]

The electrochemical sensor unit according to any one of [8] to [10], in which one of the electrochemical sensor parts is connected to one of the IQ conversion circuits.

[12]

The electrochemical sensor unit according to any one of [8] to [11], in which
two or more of the electrochemical sensor parts are each connected to one of the IQ conversion circuits.
   [13]

The electrochemical sensor unit according to any one of [8] to [12], further including
an identification system unit that identifies the chemical substance on the basis of outputs from the response signal output circuits.
   [14]

The electrochemical sensor unit according to any one of [1] to [13], in which
the sensitive membrane contains an organic polymer.
   [15]

The electrochemical sensor unit according to any one of [1] to [14], in which
the sensitive membrane contains an inorganic material.
   [16]

The electrochemical sensor unit according to any one of [1] to [15], in which
the sensitive membrane contains an olfactory cell.
   [17]

The electrochemical sensor unit according to any one of [1] to [16], in which
the sample is in any of a gaseous state, a liquid state, a semi-solid state, and a solid state.
   [18]

An odor component electrochemical sensor unit including
two or more electrochemical sensor parts each connected to one AC signal generation unit, in which
each of the electrochemical sensor parts includes a sensitive membrane having a physical property that changes in response to an odor component in a sample, and
the sensitive membranes are separated from each other via at least one of an insulating membrane or an electrode in plan view.
   [19]

A method for manufacturing an electrochemical sensor unit, the method including:
forming sensitive membranes having a physical property that changes in response to a chemical substance in a sample; and
separating the sensitive membranes from each other via at least one of an insulating membrane or an electrode in plan view.

### REFERENCE SIGNS LIST

1 Electrochemical sensor unit
11 AC signal generation unit
12 Electrochemical sensor part
121 Sensitive membrane
122 Insulating membrane
123 Electrode
123A IQ electrode
123B AC electrode
124 Via
125 Wire line
13 Response signal output circuit
131 IQ conversion circuit
132 AD conversion circuit
14 Identification system unit

1. An electrochemical sensor unit comprising
two or more electrochemical sensor parts each connected to one alternating current (AC) signal generation unit, in which
each of the electrochemical sensor parts includes a sensitive membrane having a physical property that changes in response to a chemical substance in a sample, and
the sensitive membranes are separated from each other via at least one of an insulating membrane or an electrode in plan view.

2. The electrochemical sensor unit according to claim 1, wherein
at least some of the electrochemical sensor parts are arranged in an array.

3. The electrochemical sensor unit according to claim 1, wherein
types of the sensitive membranes included in two or more of the electrochemical sensor parts are different from each other.

4. The electrochemical sensor unit according to claim 1, wherein
the sensitive membrane has a contact surface in contact with the chemical substance, and
the contact surfaces included in two or more of the electrochemical sensor parts each have a different size.

5. The electrochemical sensor unit according to claim 4, wherein
sizes of the contact surfaces are different depending on the types of the sensitive membranes.

6. The electrochemical sensor unit according to claim 1, wherein
frequencies of the AC signal generation unit to be input to two or more of the electrochemical sensor parts are different from each other.

7. The electrochemical sensor unit according to claim 3, wherein
frequencies of the AC signal generation unit to be input to two or more of the electrochemical sensor parts are different depending on at least one of the types or sizes of the sensitive membranes.

8. The electrochemical sensor unit according to claim 1, further comprising
one or more response signal output circuits that output response signals from the electrochemical sensor parts, wherein
at least some of the response signal output circuits include an in-phase/quadrature-phase (IQ) conversion circuit, and
at least some of the electrodes include an IQ electrode connected to the IQ conversion circuit and an AC electrode connected to the AC signal generation unit.

9. The electrochemical sensor unit according to claim 8, wherein
the sensitive membrane has a contact surface in contact with the chemical substance, and
the IQ electrode and the AC electrode are arranged on an opposite side of the contact surface.

10. The electrochemical sensor unit according to claim 8, wherein
an area where the IQ electrode and the sensitive membrane are in contact with each other and an area where the AC electrode and the sensitive membrane are in contact with each other are substantially same.

11. The electrochemical sensor unit according to claim 8, wherein
one of the electrochemical sensor parts is connected to one of the IQ conversion circuits.

12. The electrochemical sensor unit according to claim 8, wherein
two or more of the electrochemical sensor parts are each connected to one of the IQ conversion circuits.

13. The electrochemical sensor unit according to claim 8, further comprising
an identification system unit that identifies the chemical substance on a basis of outputs from the response signal output circuits.

14. The electrochemical sensor unit according to claim 1, wherein
the sensitive membrane contains an organic polymer.

15. The electrochemical sensor unit according to claim 1, wherein
the sensitive membrane contains an inorganic material.

16. The electrochemical sensor unit according to claim 1, wherein
the sensitive membrane contains an olfactory cell.

17. The electrochemical sensor unit according to claim 1, wherein
the sample is in any of a gaseous state, a liquid state, a semi-solid state, and a solid state.

18. An odor component electrochemical sensor unit comprising
two or more electrochemical sensor parts each connected to one AC signal generation unit, wherein
each of the electrochemical sensor parts includes a sensitive membrane having a physical property that changes in response to an odor component in a sample, and
the sensitive membranes are separated from each other via at least one of an insulating membrane or an electrode in plan view.

19. A method for manufacturing an electrochemical sensor unit, the method comprising:
forming sensitive membranes having a physical property that changes in response to a chemical substance in a sample; and
separating the sensitive membranes from each other via at least one of an insulating membrane or an electrode in plan view.
